(19) United States
(12) Patent Application Publication
(10) Pub. No.: US 2018/0286275 A1
(43) Pub. Date: Oct. 4, 2018

(54) PERSONALIZED ASSESSMENT SYSTEM FOR CHILDREN'S NUTRITIONAL FOOD AND LIVING ENVIRONMENT

(71) Applicant: Union Applied Gene Inc., Taipei City (TW)

(72) Inventors: Hung-Wei SHU, New Taipei City (TW); Li-Wei Lin, New Taipei City (TW)

(21) Appl. No.: 15/473,637

(22) Filed: Mar. 30, 2017

(51) Int. Cl. G09B 19/00; G06F 19/00; G09B 5/02

(52) U.S. Cl. CPC G09B 19/0092; G09B 5/02; G06F 19/3475

(57) ABSTRACT

A personalized assessment system for children's nutritional food and living environment, wherein a user interface is connected to an analysis server to perform data access and browsing. Data inputted by an user is calculated in the analysis server, a children's body constitution classification database, a children nutritional food ingredient database and a children's living environment advice database, the analysis server saves a data after interaction analysis into the analysis result database, the user interface provides access to the analysis result database to obtain historical data of result analysis. With the web browsing interface connected to the cloud server, the user can access result data via the internet, so as to understand children's innate body constitution and personal nutritional food ingredient advice. The analysis server then sends the result data to the analysis result database, and the cloud server can access the data contained in the analysis result database.

### BACKGROUND

### Field of the Invention

The present invention relates to an assessment system, and more particularly to a personalized assessment system for children's nutritional food and living environment.

### Related Prior Art

The healthy growth of children is the top most concern of parents, the key to the healthy growth lies in the children's innate DNA, and DNA gene determines the future of the child's physical and mental development. There is a great variety of infant foods for children's growth and development. Parents often do not know how to choose, most of them can only refer to other users' experience, but can not be sure whether these products are really suitable for their children. Every child is unique, the body constitution for each child is different due to the innate DNA is different, consequently the nutrition they need is also different. Therefore, only the choice of appropriate infant foods based on individual body constitution can accurately and effectively facilitate children's healthy growth and development.

For example, Taiwan Pat. NO. 201535301 discloses a gene testing method capable of testing 14 different genes to judge the individual adaptive development, which is used as the evaluation data for children's education. However, individually adaptive education and learning will be helpful to the development of natural potential, but is very limited to the growth and development of children. Diet plays an important role in children' growth and development, only focusing on education while ignoring the choosing of appropriate nutritional infant foods are not good for fully development and growth of the children.

Based on the children's body constitution and development related gene detection, the present invention acquires children's innate body constitution and growth characteristic through analysis and comparison, and provides optimum advices on infant nutritional food and living environment based for each individual body constitution. With the aid of the cloud platform, parents can fully understand their children's innate body constitution, which is therefore helpful to the children's growth and development in a more effective and accurate way.

The present invention has arisen to mitigate and/or obviate the afore-described disadvantages.

### SUMMARY

One objective of the present invention is to provide a personalized assessment system for children's nutritional food and living environment. The system can automatically and interactively analyze and calculate the inputted gene detection data regarding children's personal data and growth body constitution with the plurality of connected databases. Finally, the analysis result produces children's personalized nutritional food and living environment advice. The personalized information allows users to fully understand their children's innate body constitution and corresponding needs, which are accurately and effectively helpful to children's healthy growth and development.

To achieve the above objective, a personalized assessment system for children's nutritional food and living environment, comprises: a user interface, a children's body constitution classification database, an analysis server, a children nutritional food ingredient database, a children's living environment advice database, an analysis result database, a cloud server, and a web browsing interface; wherein the user interface is connected to the analysis server to perform data access and browsing, the analysis server is connected to the children's body constitution classification database, the children nutritional food ingredient database, the children's living environment advice database and the analysis result database, data inputted by an user is calculated in the analysis server, the children's body constitution classification database, the children nutritional food ingredient database and the children's living environment advice database, the analysis server then picks up and saves a data after interaction analysis into the analysis result database, the user interface provides access to the analysis result database to obtain historical data of result analysis, the cloud server is connected to the analysis result database, with the web browsing interface which is connected to the cloud server, the user is able to access result data via the internet, so as to understand children's innate body constitution and personal nutritional food ingredient advice. The analysis server then sends the result data to the analysis result database, and the cloud server can access the data contained in the analysis result database.

With the technique and device of the present invention, a user can input gene detection data regarding children's personal data and growth body constitution to the analysis server, then sends to the children's body constitution classification database to perform data comparison and exchange, so as to obtain personal innate body constitution information. The analysis server then sends the personal body constitution information to the children nutritional food ingredient database to perform data integration and analysis, so as to obtain personalized advice on children's nutritional food ingredient formula and living environment. The personalized assessment system can instantly provide detailed advice on children's nutritional food ingredient and living environment, which further assists parents in selecting of suitable child nutrition food, improving children's lifestyle, and building a good home environment. The correct and optimized personal advice is believed to be helpful to children's healthy growth and development.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a block diagram of a personalized assessment system for children's nutritional food and living environment in accordance with a preferred embodiment of the present invention;

FIG. 2 is an illustrative view of the personalized assessment system for children's nutritional food and living environment in accordance with a preferred embodiment of the present invention;

FIG. 3 is an illustrative view showing the body constitution information;

FIG. 4 is an illustrative view showing the analysis of the children's nutritional food ingredients;

FIG. 5 is an illustrative view showing the children's nutritional food ingredients; and

FIG. 6 is a block diagram showing the operation of the personalized assessment system for children's nutritional food and living environment in accordance with the present invention.

### DETAILED DESCRIPTION

The present invention will be clearer from the following description when viewed together with the accompanying drawings, which show, for purpose of illustrations only, the preferred embodiment in accordance with the present invention.

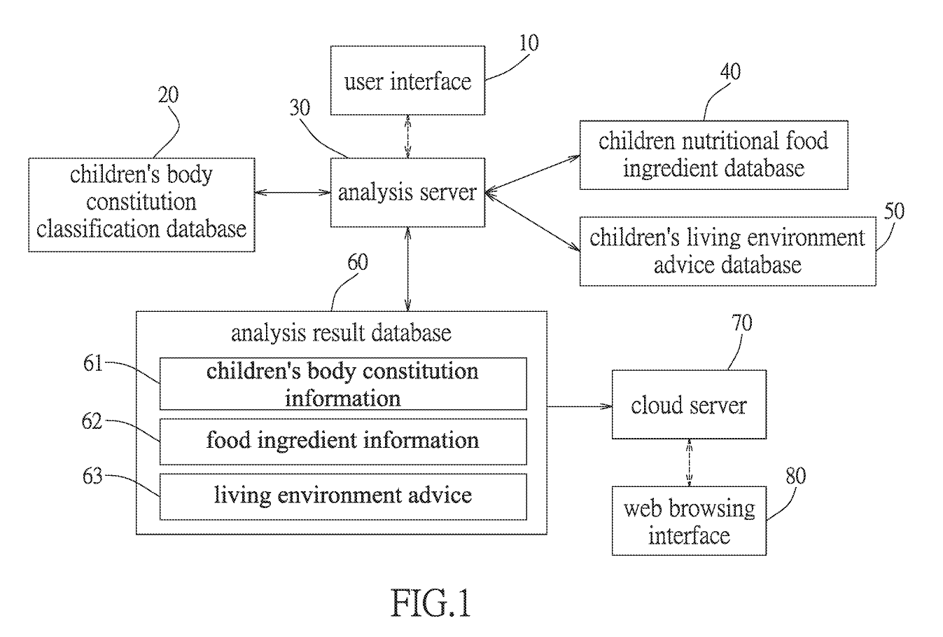

Referring to FIG. 1, a personalized assessment system for children's nutritional food and living environment in accordance with a preferred embodiment of the present invention is shown and comprises: a user interface 10, a children's body constitution classification database 20, an analysis server 30, a children nutritional food ingredient database 40, a children's living environment advice database 50, an analysis result database 60, a cloud server 70, and a web browsing interface 80.

The user interface 10 can be logged in a wire or wireless manner and is connected to the analysis server 30 which is also connected to the children's body constitution classification database 20, the children nutritional food ingredients database 40, the children's living environment advice database 50, and the analysis result database 60. The analysis server 30 is used as a data exchange, calculation and transmission center for data analysis and integration. The web browsing interface 80 can be logged in a wire or wireless manner via the user interface and is connected to the cloud server 70, and the cloud server 70 is connected to the analysis result database 60 to perform data access, which provides an instant and convenient result browsing method for the users or customers.

Children's personal data and gene detection data is inputted in the user interface 10 by a user, and are then transmitted to the analysis server 30, and then the analysis server 30 transmits the children's personal data and gene detection data to the children's body constitution classification database 20 to perform data comparison and exchange, so as to acquire children's personal innate body constitution information.

The analysis server 30 picks up and transmits the children's personal innate constitution information and a basic information to the children nutritional food ingredient database 40 and the children's living environment advice database 50 to perform data analysis and calculation, so that nutritional food ingredient formula and living environment advice suitable for children's personal innate body constitution is obtained.

The analysis server 30 picks up and integrates the nutritional food ingredient formula and living environment advice suitable for children's personal innate body constitution with the children's personal innate constitution information and the basic information, and then data is formatted automatically and transmitted to and stored in the analysis result database 60. The data stored in the analysis result database 60 includes children's body constitution information 61, food ingredient information 62 and living environment advice 63. All the data and information can be accessed and traced via the user interface 10.

The web browsing interface 80 is connected to the cloud server 70, and the cloud server 70 can access the analysis result database 60, which provides an instant and convenient result browsing method for the users or customers to fully understand their children's innate body constitution, and provides an appropriate and optimum nutritional food ingredient formula and living environment advice which is accurately and effectively helpful to children's healthy growth and development.

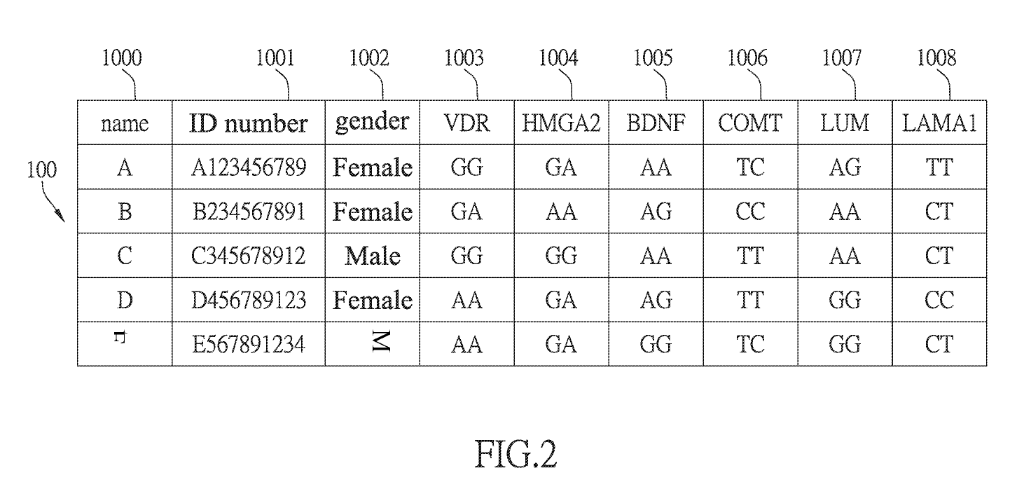

For a better understanding the personalized assessment system for children's nutritional food and living environment in accordance with the present invention, reference should be made to FIG. 2. A user can input a plurality of pieces of personal information and gene detection data 100 in the form of a table into the analysis result server 30 via the user interface 10. The personal information and gene detection data 100 includes name 1000, ID number (or other code) 1001, gender 1002, VDR (vitamin D receptor gene) detection result 1003, HMGA2 (High Mobility Group AT-Hook 2) detection result 1004, BDNF (brain derived neurotrophic factor gene) detection result 1005, COMT (Catechol-o-methyltransferase) detection result 1006, LUM (Lumican gene) detection result 1007, and LAMA1 (Laminin subunit alpha 1 gene) detection result 1008. The analysis server 30 converts the information in the table into data array for data integration and analysis.

The VDR detection result 1003 is an important gene that regulates calcium absorption, which is related to the height of a person. When active vitamin D is formed by sunlight exposure or dietary intake, it can react with the receptor to strengthen the calcium absorption in the small intestine. When the calcium absorption in the body is insufficient, it will slow down the osteogenic action and affect the bone development, resulting in a slowing down of height growing process. Therefore, the ability of VDR gene is very closely related to the development and growth (height growing) of a child.

The HMGA2 is a key gene that determines the growth and development of a child. With the development going on, the expression of the HMGA2 gene becomes less and less, and the ability of the HMGA2 determines the height growing speed. The HMGA2 gene can regulate the growth of bone and muscle by coordinating the combination of biological molecules in the cell. When the function of the gene is good, the child's growth will be accelerated, bone density will increase, thereby promoting the healthy growth of height.

The BDNF 1005 is the key gene for regulating the growth, survival and differentiation of cranial nerve, and the ability of BDNF 1005 determines the neural activity in the brain. Besides the influence of cognition, neural activity is also related to the development of intelligence. The BDNF 1005 enhances the neural activity in the brain, strengthens the connection between cranial nerves, consequently promoting the improvement of intelligence.

The COMT 1006 is a key gene for regulating dopamine metabolism. In the brain, dopamine is closely associated with the brain nerve conduction. The ability of COMT gene is strong, it will accelerate the decomposition of dopamine, which will result in dopamine level reduction, thereby affecting the neural activity. Neural activity can promote the connection of cranial nerves, and strengthen brain function. Therefore, there is a close relationship between the COMT gene and the improvement of intelligence.

The LUM 1007 is an important gene that controls the development of eyeball and the maintenance of eyeball structure, which is associated with the development of children's vision. In addition to the influence on the stability of the eye structure and the transparency of the cornea, the LUM gene is also associated with the interaction of sclera extracellular matrix. By the function of this gene, the stability of the shape and size of the eyeball can be maintained in the growth process of children, so as to achieve the effect of children's vision health protection.

The LAMA1 1008 is important to determine the structural stability of the retina, and the stability of retinal structure is very important to the vision health. In addition to the growth of the eyeball, the strength or ability of the LAMA 1 is also related to the protection of optic nerve cell. When the function of this gene is good, the retina is less prone to dislocation, which consequently protects the children's eyes' structure and vision health.

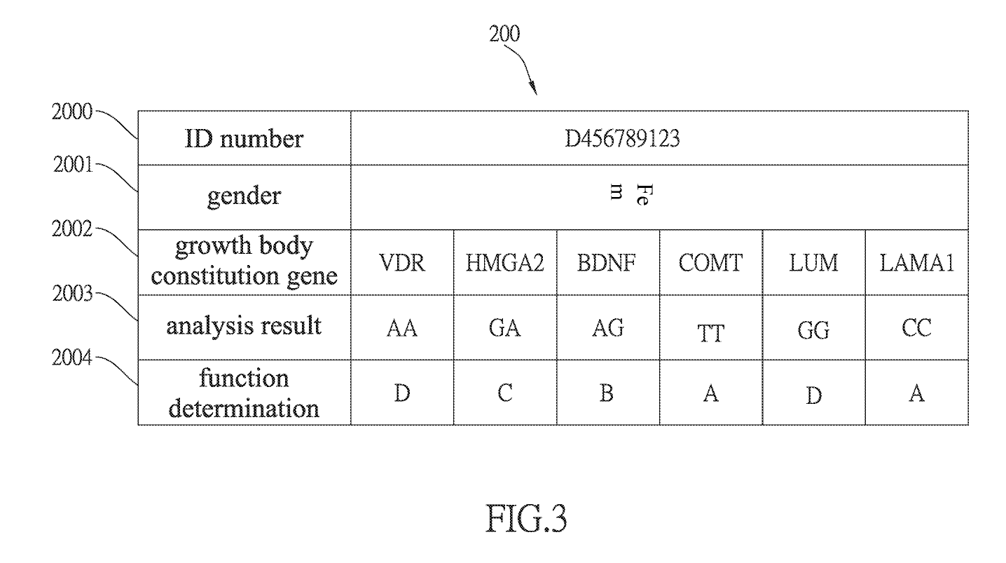

The analysis server 30 sends the personal information and gene detection data 100 to the children's body constitution classification database 20 to perform data comparison and exchange, so as to obtain personal innate body constitution information 200 which includes ID number 2000, gender 2001, and detection result 2003 and function determination 2004 for six growth body constitution genes 2002 (VDR, HMGA2, BDNF, COMT, LUM and LAMA1), as shown in FIG. 3. The function determination 2004 is made based on the weighted analysis of gender and gene detection data. Gene function is classified into levels A, B, C and D. Level A means that the gene function is normal, the gene function of level B is inferior to that of level A, the gene function of level C is inferior to that of level B, and the gene function of level D is the worst of all. The gender 2001 and function determination 2004 for the six growth genes, including the VDR, HMGA2, BDNF, COMT, LUM and LAMA1, provide important personal innate body constitution information 200, which is used as reference data for children's nutritional food ingredient formula and living environment advice.

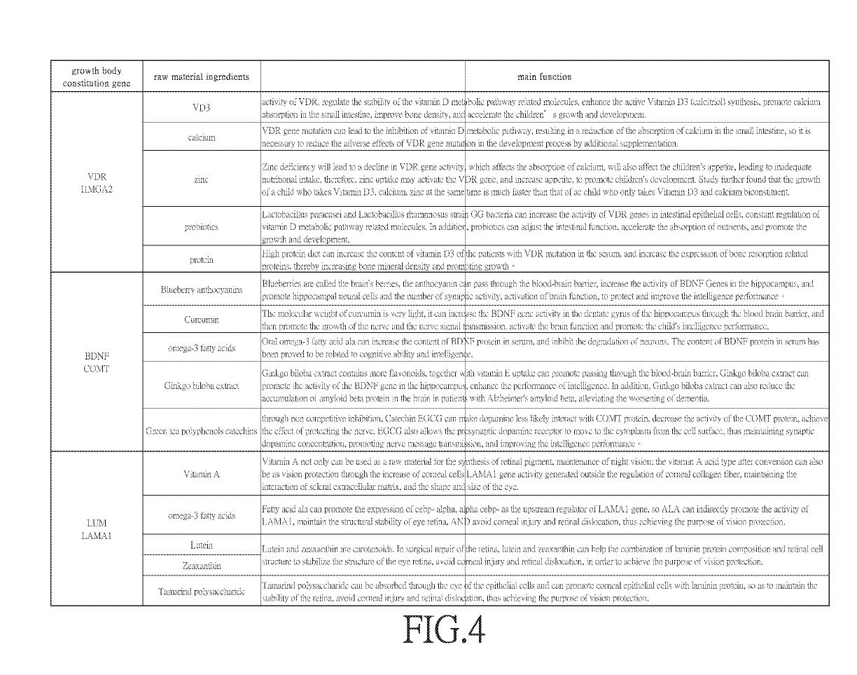

In this embodiment, the children nutritional food ingredient database 40 which is connected to the analysis server 30 includes different children's nutritional food ingredient information 300 corresponding to different growth genes, as shown in FIG. 4. The corresponding raw material ingredients 3001 stored the children nutritional food ingredient database 40 are all studied and evaluated, for example, the main function 3002 of each of the corresponding raw material ingredients 3001 can compensate for the functional disorder caused by the functional decrease of the growth body constitution gene 3000. Besides the corresponding raw material ingredients 3001, the children nutritional food ingredient database 40 further includes the function information, the effective dose and the safe dose range of the formula raw material, which is used as a reliable and effective reference basis for the children's personal nutritional food ingredient. The analysis server 30 is also connected to the children's living environment advice database 50 which contains a variety of living habit and living environment advices on improvement of insufficiency of function of various genes, so that parents can not only promote children's growth and development from food, but also can help the children's development from the improvement of the living environment.

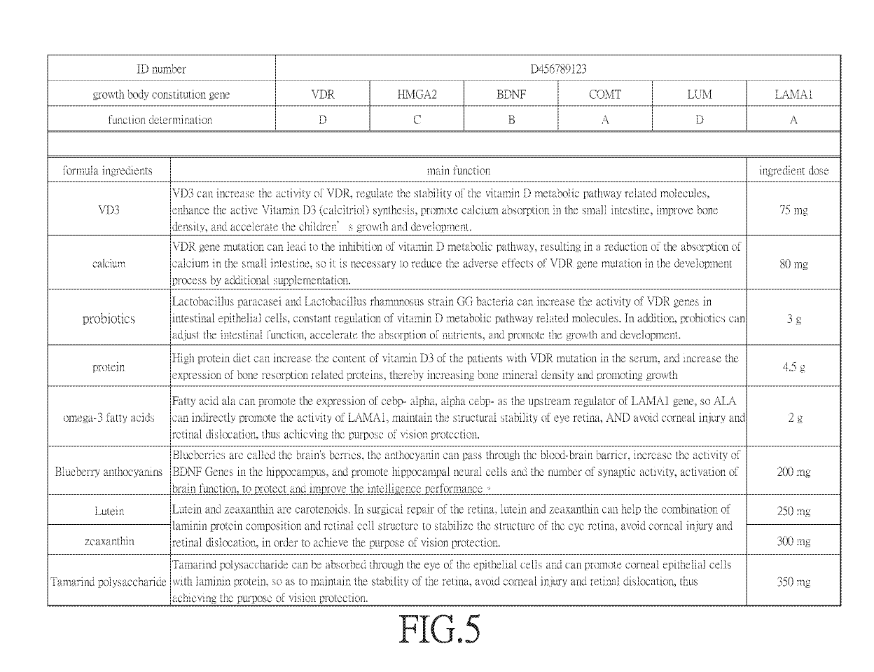

The analysis server 30 picks up and transmits the children's personal innate constitution information 200 to the children nutritional food ingredient database 40 and the children's living environment advice database 50 to perform data analysis and calculation, so as to obtain personalized children's nutritional food ingredient formula and living environment advice. The children's personalized nutritional food ingredient information 400 is shown in FIG. 5. The analysis server 30 sends a completed personal body constitution information, including ID (identity card No) 4000, growth body constitution gene 4001 and function determination 4002, to the children nutritional food ingredient database 40 to perform data integration and analysis, so as to obtain personalized formula composition 4003, main function 4004, component dose 4005. After study and evaluation, the formula composition 4003 can help children with this body constitution to grow and develop more properly and effectively. The component dose 4005 provides accurate and safe personalized children nutritional food ingredient dose based on studying and evaluation of individual innate body constitution information.

The analysis server 30 obtains and integrates the personalized children's nutritional food ingredient formula and living environment advice with the individual innate body constitution information and personal basis information, and then reorganizes and formats data, and sends the data to the analysis result database 60. The data includes children body constitution information 61, food ingredient information 62, and living environment information 63. The children body constitution information 61 includes name 1000, ID number 2000, function determination 2004 of the growth body constitution genes 2002 (personalized innate body constitution). The food ingredient information 62 includes personalized formula composition 4003, main function 4004, component dose 4005, safe dose range, and dose allocation. The living environment advice 63 includes advice on living habit improvement and home environment. The information contained in the analysis result database 60 can be assessed and traced via the user interface 10, assisting users to quickly and efficiently search and analyze data and results.

Besides the analysis server 30, the analysis result database 60 is also connected to the cloud server 70. The cloud server 70 can be assessed and operated by the web browsing interface 80 which provides an interface for intuitive data management and information browsing, so that the users or customers can access the personalized data and result information in the analysis result database 60, and the cloud server 70 ensures the correctness and security of data access. Users or customers can fully understand the children's innate body constitution by browsing the analysis results and reports through this instant and convenient way. With the appropriate and optimum personalized nutrition ingredients for children, as well as the advice on improvement of lifestyle and home environment, users can help children to grow up and develop in a more accurate and effective way.

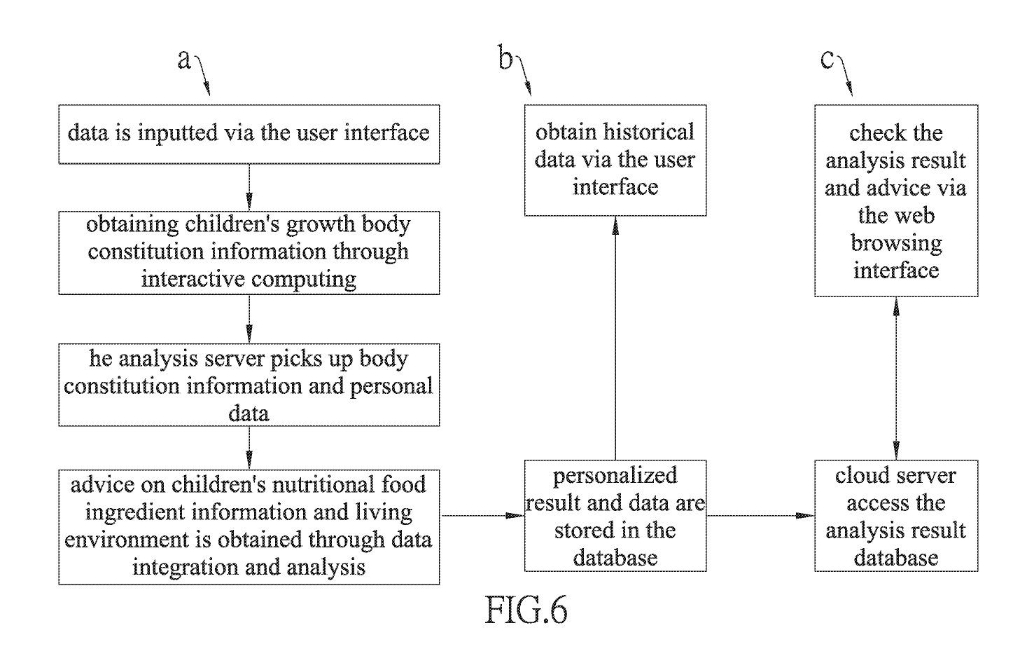

To summarize, the present invention provides a personalized assessment system for children's nutritional food and living environment, as shown in FIG. 6. a, after a user inputs data into the user interface 10, the analysis server 30 will calculates and compares the data with the children's body constitution classification database 20, to obtain personal innate body constitution information, and the analysis server 30 transmits the children's personal innate constitution information and a basic information to the children nutritional food ingredient database 40 and the children's living environment advice database 50 to perform data analysis and calculation, so as to obtain personalized children's nutritional food ingredient formula and living environment advice; b, the personalized children's nutritional food ingredient formula and living environment advice is then stored in the analysis result database 60, the historical analysis data can be traced through the user interface 10 to assist the user to search and analysis data and the result information quickly; c, the analysis result 60 is also connected to the cloud server 70, users can access the analysis result data base 60 via the web browsing interface and the cloud server 70, which provides an instant and convenient result browsing method for the users or customers to fully understand their children's innate body constitution, and provides an appropriate and optimum nutritional food ingredient formula and living environment advice which is accurately and effectively helpful to children's healthy growth and development.

The personalized assessment system for children's nutritional food and living environment in accordance with the present invention is an integrated analysis method, which is capable of quickly and precisely providing advices on children's nutritional food ingredient and lifestyle based on different types of innate body constitutions. The users can easily and conveniently browse the result reports and analysis data. With the appropriate and optimum personalized nutrition ingredients for children, as well as the advice on improvement of lifestyle and home environment, users can help children to grow up and develop in a more accurate and effective way.

While we have shown and described various embodiments in accordance with the present invention, it is clear to those skilled in the art that further embodiments may be made without departing from the scope of the present invention.

What is claimed is:

1. A personalized assessment system for children's nutritional food and living environment, comprising: a user interface, a children's body constitution classification database, an analysis server, a children nutritional food ingredient database, a children's living environment advice database, an analysis result database, a cloud server, and a web browsing interface; wherein the user interface is connected to the analysis server to perform data access and browsing, the analysis server is connected to the children's body constitution classification database, the children nutritional food ingredient database, the children's living environment advice database and the analysis result database, data inputted by an user is calculated in the analysis server, the children's body constitution classification database, the children nutritional food ingredient database and the children's living environment advice database, the analysis server then picks up and saves a data after interaction analysis into the analysis result database, the user interface provides access to the analysis result database to obtain historical data of result analysis, the cloud server is connected to the analysis result database, with the web browsing interface which is connected to the cloud server, the user is able to access result data via the internet, so as to understand children's innate body constitution and personal nutritional food ingredient advice.

2. The personalized assessment system for children's nutritional food and living environment as claimed in claim 1, wherein the user interface is allowed to be logged in a wire or wireless manner, and is connected to the analysis server.

3. The personalized assessment system for children's nutritional food and living environment as claimed in claim 1, wherein the web browsing interface is allowed to be logged in a wire or wireless manner via the user interface and is connected to the cloud server.

4. The personalized assessment system for children's nutritional food and living environment as claimed in claim 1, wherein children's personal data and gene detection data is inputted in the user interface by a user, and are then transmitted to the analysis server, and then the analysis server transmits the children's personal data and gene detection data to the children's body constitution classification database to perform data comparison and exchange, so as to acquire children's personal innate body constitution information.

5. The personalized assessment system for children's nutritional food and living environment as claimed in claim 1, wherein the data includes children's body constitution information, food ingredient information and living environment advice.
